(19) United States
(12) Patent Application Publication
(10) Pub. No.: US 2011/0202414 A1
(43) Pub. Date: Aug. 18, 2011

(54) METHOD AND APPARATUS FOR PROVIDING VISUAL FEEDBACK THROUGH A PHYSICAL MECHANISM

(75) Inventors: Srinivasan Nallasivan, Charlotte, NC (US); David D. Price, Kennewick, WA (US)

(73) Assignee: Bank of America, Charlotte, NC (US)

(21) Appl. No.: 12/707,866

(22) Filed: Feb. 18, 2010

(51) Int. Cl. G06Q 40/00; G06Q 20/00

(52) U.S. Cl. 705/17; 705/41; 705/35

(57) ABSTRACT

Thus, systems and methods for providing visual feedback for a banking customer have been provided. Such systems may include a financial instrument preparation device. Such a device may be used for providing cues to a banking customer. The financial instrument preparation device may include a cueing panel and an integrated silicon chip. The chip may further include a communications module for receiving an electronic signal relating to the banking customer's account balance. The chip may also include a computer processing unit for storing the electronic signal in a computer memory. In addition the chip may include an output signal connected to the cueing panel. The output signal may be based, at least in part, on the electronic signal.

### FIELD OF TECHNOLOGY

This invention relates to the field of customer care. More particularly it relates to the issue of customer bank accounts.

### BACKGROUND OF THE INVENTION

The invention relates to the field of service provided to banking customers. Customers of banks and other financial institutions—e.g., credit unions, brokerages etc.—often have one or multiple accounts which are drawn upon to make purchases. Because of the complexity of modern banking and the practice of keeping many different accounts, as well as the practice of automatic withdrawals for the payment of regularly occurring bills, customers may overdraw accounts.

Overdrawing of accounts is undesirable as it may lead to increasing fees for overdraft lending, loss of service and/or insurance coverage if an automatic withdrawal cannot be made. Likewise the inability to pay a restaurant bill may lead to public humiliation or loss of business, should a credit card be declined at the conclusion of a crucial business meeting.

Therefore it would be desirable to provide systems that will warn banking customer that accounts are in arrears or are close to being in arrears. Such systems may provide a visual cue such as a color change as a sign that the account is in arrears.

### SUMMARY OF THE INVENTION

Banking customers access funds in various accounts by the use of multiple mechanisms,—e.g., credit cards, check writing etc. The level of the funds available in a particular account may be tracked by the customer—i.e., by means of a paper checkbook entry system, by means of software or by any other suitable method. However, oftentimes customers may make a payment in the absence of a checkbook or may use a mechanism such as a credit card or a debit card and will be unaware of the current level of funds present in the account.

In some embodiments of the invention cues are presented to the customer as a color change or a change in iconography of a portion of the interface that presents itself to the customer during the payment of funds. The interface to the customer may be embodied as a computer interface, a credit/debit card, an electronic checkbook or any other suitable interface.

In another embodiment of the invention the cues may be presented by a standalone device such as keychain fob, through a portable electronic device such as a personal digital assistant (PDA), a cell phone or any other suitable device.

Although the cues presented thus far may be used to warn customers regarding the level of funds in a particular account other types of warnings such as those concerning illicit access to an account, the presence of funds in an alternative account as well as other warnings or informational messages or cues may also be presented to the customer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram of one embodiment of a computer system implementing a Graphical User Interface (GUI) according to the invention where the customer account is well funded.

FIG. 2 shows an illustrative diagram of one embodiment of a computer system implementing a GUI according to the invention where the customer account has fallen below a threshold.

FIG. 3 shows an illustrative diagram of one embodiment of a computer system implementing a GUI according to the invention where the customer account is in arrears—i.e., negative.

FIG. 4 shows an illustrative diagram of one embodiment of a credit card implementing a cueing area according to the invention where the customer account is well funded.

FIG. 5 shows an illustrative diagram of one embodiment of a credit card implementing a cueing area according to the invention where the customer account has fallen below a threshold.

FIG. 6 shows an illustrative diagram of one embodiment of a credit card implementing a cueing area according to the invention where the customer account is in arrears.

FIG. 7 shows an illustrative diagram of one embodiment of a credit card implementing a visual cue utilizing the entire area of the credit card according to the invention where the customer account is well funded.

FIG. 8 shows an illustrative diagram of one embodiment of a credit card implementing a visual cue utilizing the entire area of the credit card according to the invention where the customer account has fallen below a threshold.

FIG. 9 shows an illustrative diagram of one embodiment of a credit card implementing a visual cue utilizing the entire area of the credit card according to the invention where the customer account is in arrears i.e., negative.

FIG. 10 shows an illustrative diagram of one embodiment of a key chain fob implementing a cueing area according to the invention where the customer account is well funded.

FIG. 11 shows an illustrative diagram of one embodiment of a key chain fob implementing a cueing area according to the invention where the customer account has fallen below a threshold.

FIG. 12 shows an illustrative diagram of one embodiment of a key chain fob implementing a cueing area according to the invention where the customer account is in arrears—i.e., negative.

FIG. 13 shows an illustrative diagram of one embodiment of a checkbook implementing a cueing area according to the invention where the customer account is well funded.

FIG. 14 shows an illustrative diagram of one embodiment of a checkbook implementing a cueing area according to the invention where the customer account has fallen below a threshold.

FIG. 15 shows an illustrative diagram of one embodiment of a checkbook implementing a cueing area according to the invention where the customer account is in arrears—i.e., negative.

FIG. 16 shows an illustrative diagram of one embodiment of a checkbook implementing a visual cue utilizing the entire area of the check according to the invention where the customer account is well funded.

FIG. 17 shows an illustrative diagram of one embodiment of a checkbook implementing a visual cue utilizing the entire area of the check according to the invention where the customer account has fallen below a threshold.

FIG. 18 shows an illustrative diagram of one embodiment of a checkbook implementing a visual cue utilizing the entire area of the check according to the invention where the customer account is in arrears—i.e., negative.

FIG. 19 is a schematic diagram of an electronic circuit according to the invention.

### DETAILED DESCRIPTION OF THE INVENTION

The system, methods and apparatus according to the invention warn a customer of impending or actual difficulties concerning the status of an account. The systems may implement a visual cue an audio cue, a tactile cue—e.g., temperature change or any other suitable cue or combination of cues. The cues inform the customer that an account is either well funded, below a threshold (which may indicate a balance that is considered low, wither with respect to a user defined threshold or with respect a system set threshold) or actually in arrears. The cues may be provided visually—e.g., by a color change, over part or the entirety of the interface used to access the account.

Some embodiments of this invention make use of well known bank account access methods such as plastic credit cards, paper checks or on-line banking systems implemented by software running on a computer. In at least each of these familiar banking access methods, a customer cueing panel may be implemented so that appropriate cue may be brought to the customer's attention. The cue may be indicated by color change, audio alarm or any other suitable cueing methods.

Suitable color changes are a well known symbol for warning or cueing. For example, a red light may indicate “stop” or “bad” and green light may indicate “go” or “good” and a yellow light may indicate “caution”. Other methods such as stippling dots or crosshatching may be used to implement cueing signals.

Color changes over part or all of a symbol area may be produced by a variety of technologies such as a LED display, an LCD display, photochromic inks or dyes or materials, thermochromic inks or dyes or materials, or electrochromic inks or dyes or materials or any other equivalent color changing method.

These color changing properties can be embedded in the entirety of conventional paper or plastic items—e.g., a plastic credit card or can be implanted with a reserved cueing area.

Change to the colored area can be induced by the application of electric currents, light or heat under the control of an electronic circuit according to an embodiment of the invention.

If the colored area is a part of a GUI, then a color change or symbol change may be produced by manipulation of the image via well-known software methods.

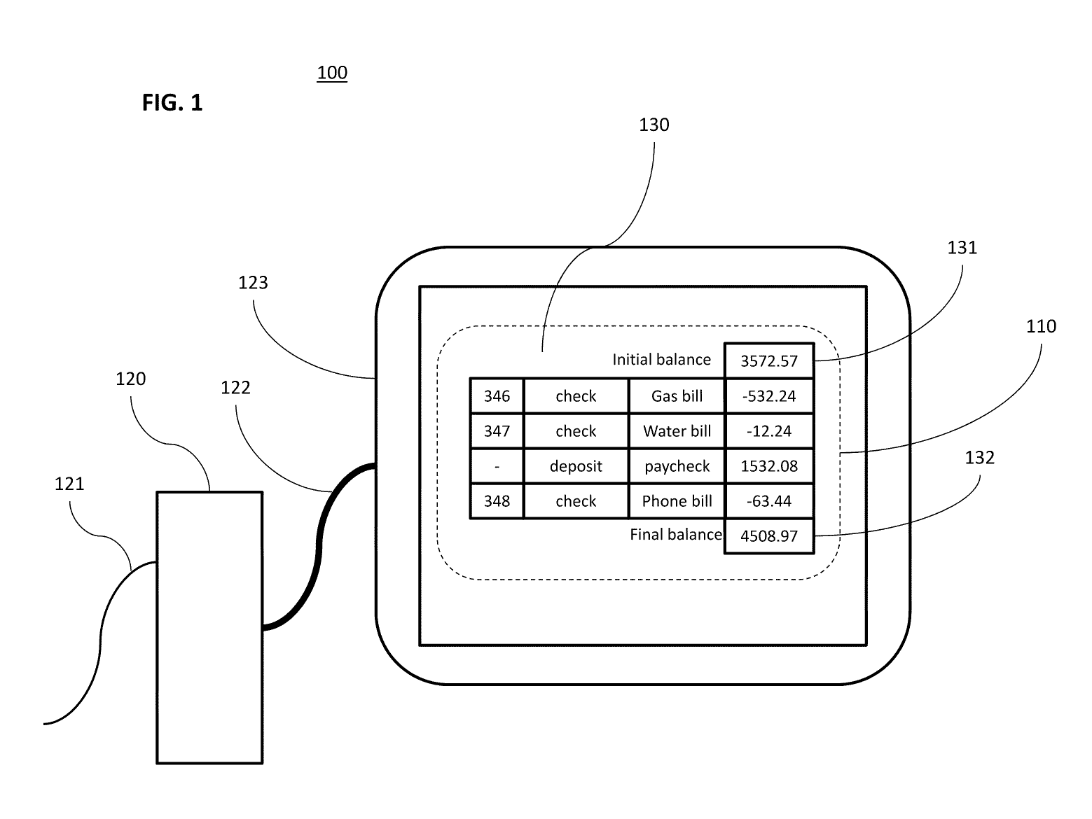

FIG. 1 shows an embodiment of a warning system 100 which may be implemented by banking software running on a computer 120 connected by a cable 122 to a monitor 121. The monitor may present a banking interface 130 showing an example of a bank account comprising a starting balance 131 and a current balance 132. The banking interface 130 may be surrounded by a cueing panel 110, which may be implemented by software, as shown by the dashed outline.

Computer 120 may be connected by the cable 121 to the Internet. The banking software running on the computer 120 may contact the bank using the Internet connection. The banking software may then update the information presented by the banking interface 130 using the information gained by contacting the bank. Likewise payments or deposits entered by the customer into the banking interface 130 may be sent to the bank via the Internet connection.

When the banking software receives account information from the bank, it may change a visual cue presented by the cueing panel 110. The change made to cueing panel 110 preferably corresponds to the current balance of the account. The current balance of the account shown by the cueing panel 110 may reflect the account balance either before or after the current transaction. Such a setting may be user-defined or system set.

Alternatively, the LED displays or other similar displays may be used to illustrate alpha-numeric characters. Such characters may be used to indicate the account balance or, in the alternative, a credit score or other suitable number.

The cueing panel 110 is shown unchanged—e.g., a white background, indicating a well funded account. The cueing panel 110 may present a different visual cue to indicate different circumstances concerning the account.

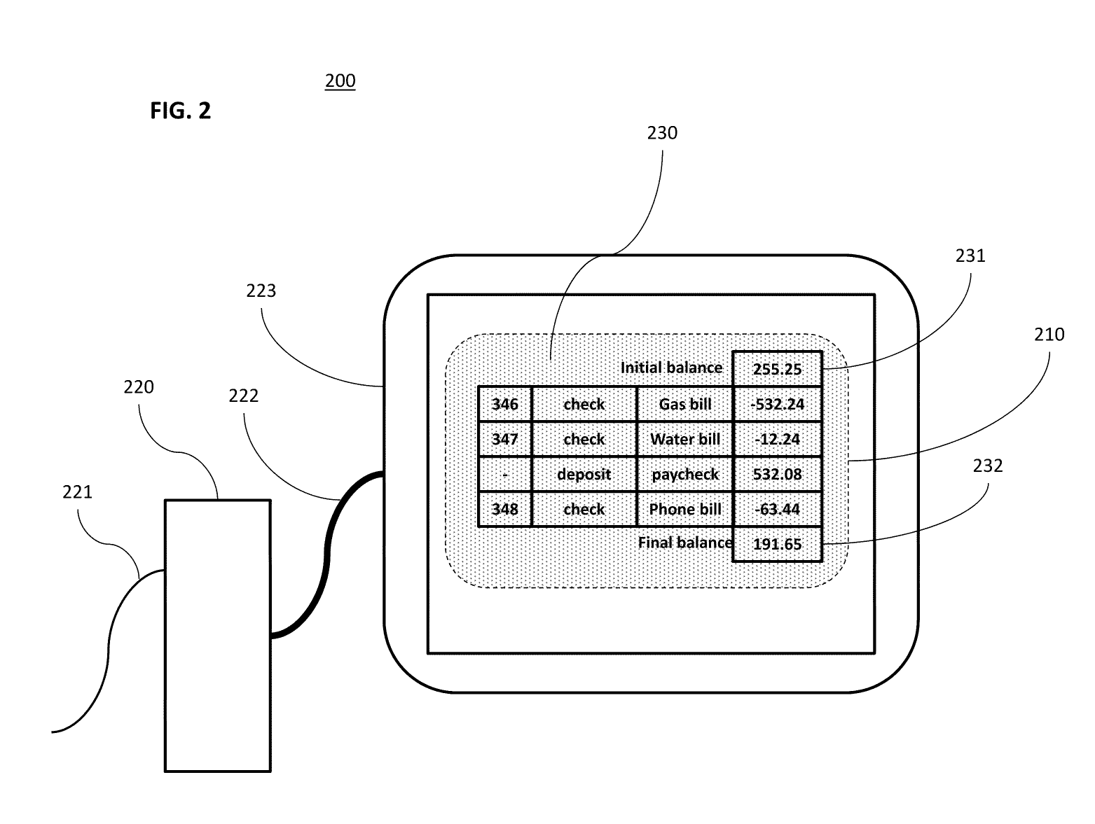

FIG. 2 shows an embodiment of a warning system 200 which may be implemented by banking software running on a computer 220 connected by a cable 222 to a monitor 221. Monitor 221 may present a banking interface 230 showing an example of a bank account comprising a starting balance 231 and a current balance 232. Banking interface 230 may be surrounded by a cueing panel 210, which may be implemented by software, as shown by the dashed outline.

Computer 220 may be connected by the cable 221 to the Internet. The banking software running on the computer 220 may contact the bank using the Internet connection. The banking software may then update the information presented by the banking interface 230 using the information gained by contacting the bank. Likewise payments or deposits entered by the customer into the banking interface 230 may be sent to the bank via the Internet connection.

The cueing panel 210 is shown as a stippled area, warning the customer that the current account balance is below a threshold,—e.g., $500.00.

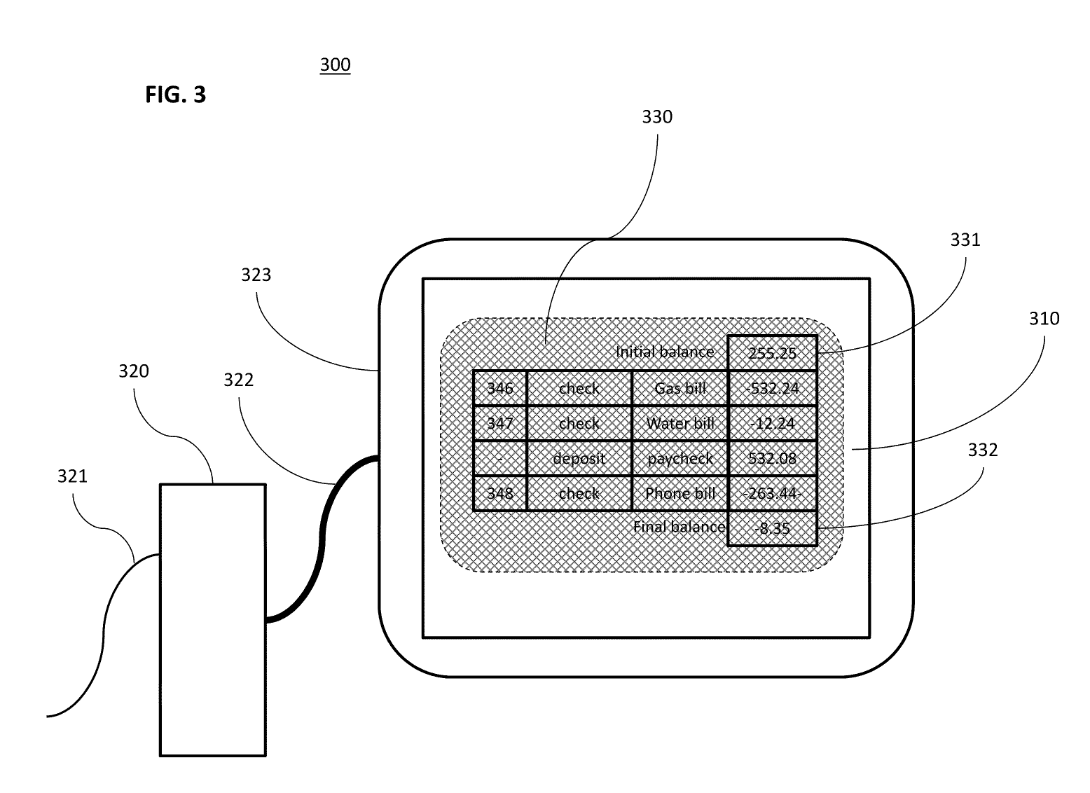

FIG. 3 shows an embodiment of a warning system 300 which may be implemented by banking software running on a computer 320 connected by a cable 322 to a monitor 321. The monitor may present a banking interface 330 showing an example of a bank account comprising a starting balance 331 and a current balance 332. The banking interface 330 may be surrounded by a cueing panel 310, which may be implemented by software, as shown by the dashed outline.

Computer 320 may be connected by the cable 321 to the Internet. The banking software running on the computer 320 may contact the bank using the Internet connection. The banking software may then update the information presented by the banking interface 330 using the information gained by contacting the bank. Likewise payments or deposits entered by the customer into the banking interface 330 may be sent to the bank via the Internet connection.

Cueing panel 310 is shown as a crosshatched area warning the customer that the current balance is in arrears—i.e., negative. A negative balance may reflect an overdraft loan and the assessment of overdraft fees. Other information such as the interest rate of the overdraft loan and a fees schedule may also be shown to the customer.

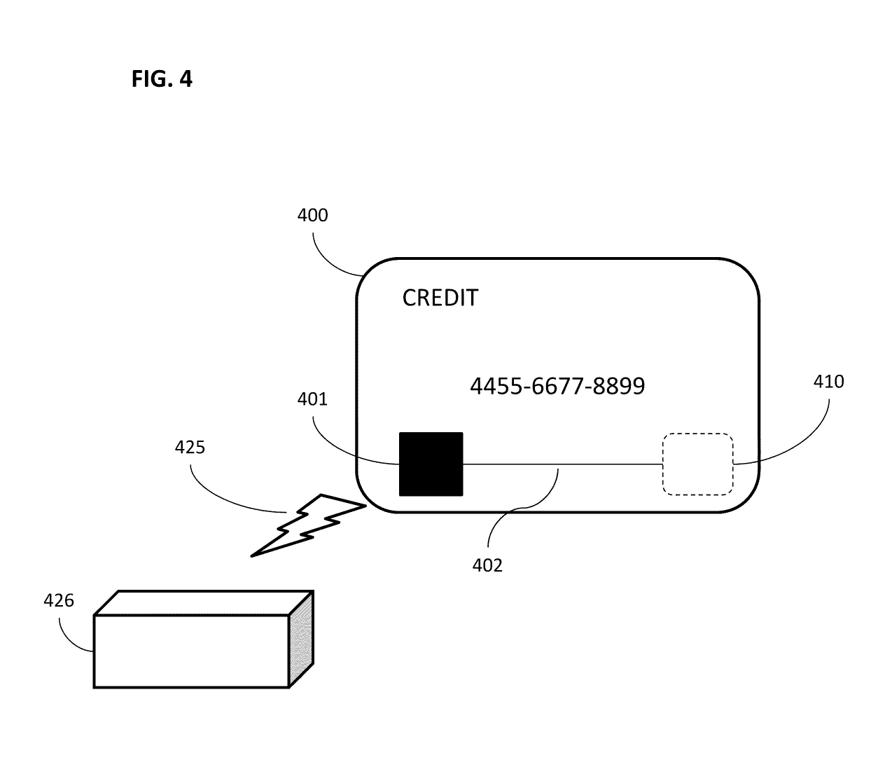

FIG. 4 shows an embodiment of a credit card 400 comprising a contactless chip 401 and a cueing panel 410. The cueing panel 410 may be implemented as an LCD panel. The contactless chip 401 may be connected to the cueing panel 410 via a wire(s) 402. The contactless chip 401 may communicate to a Point Of Sale (POS) device 426 via wireless interface 425 when payments or deposits are made to the account accessed by the credit card 400. The contactless chip 401 may also receive an account balance via wireless interface 425 and POS device 426. It should be noted that contactless chip 401 may be further characterized as an integrated silicon chip.

When the contactless chip 401 receives account information it may change the visual cue presented by cueing panel 410 via wire(s) 402. The change made to cueing panel 410 may preferably correspond to the current balance of the account. The current balance of the account shown by the cueing panel 410 may reflect the account balance either before or after the current transaction.

The cueing panel 410 is shown unchanged—e.g., a white background, indicating a well funded account. The cueing panel 410 may present a different visual cue to indicate different circumstances concerning the account.

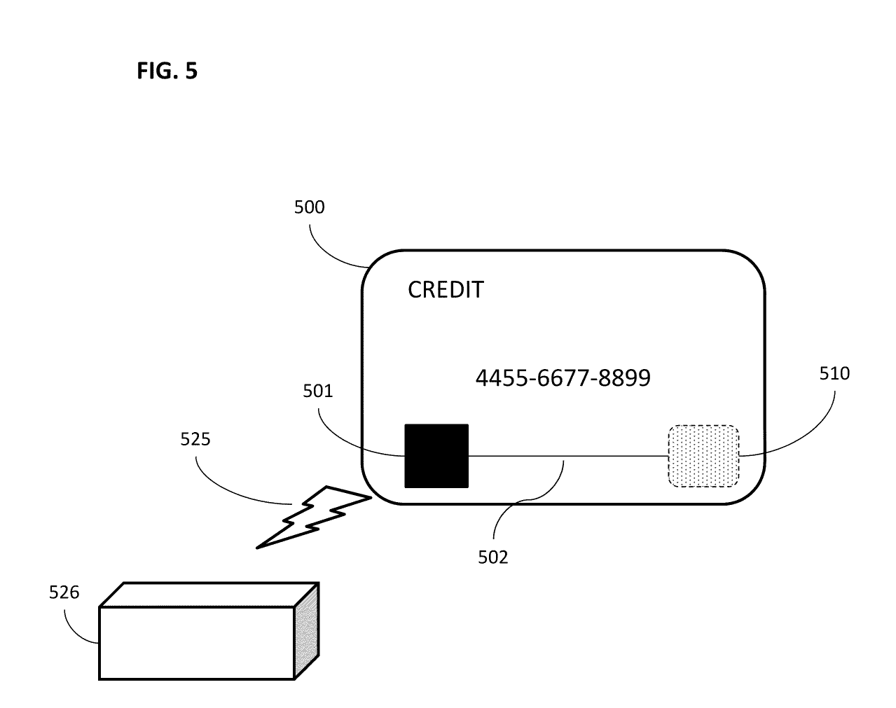

FIG. 5 shows an embodiment of a credit card 500 comprising a contactless chip 501 and a cueing panel 510. The cueing panel 510 may be implemented as an LCD panel. The contactless chip 501 may be connected to the cueing panel 510 via a wire(s) 502. The contactless chip 501 may communicate with a POS device 526 via wireless interface 525 when payments or deposits are made to the account accessed by the credit card 500. The contactless chip 501 may also receive an account balance via wireless interface 525 and POS device 526.

The cueing panel 510 is shown as a stippled area warning the customer that the current account balance has fallen below a threshold.

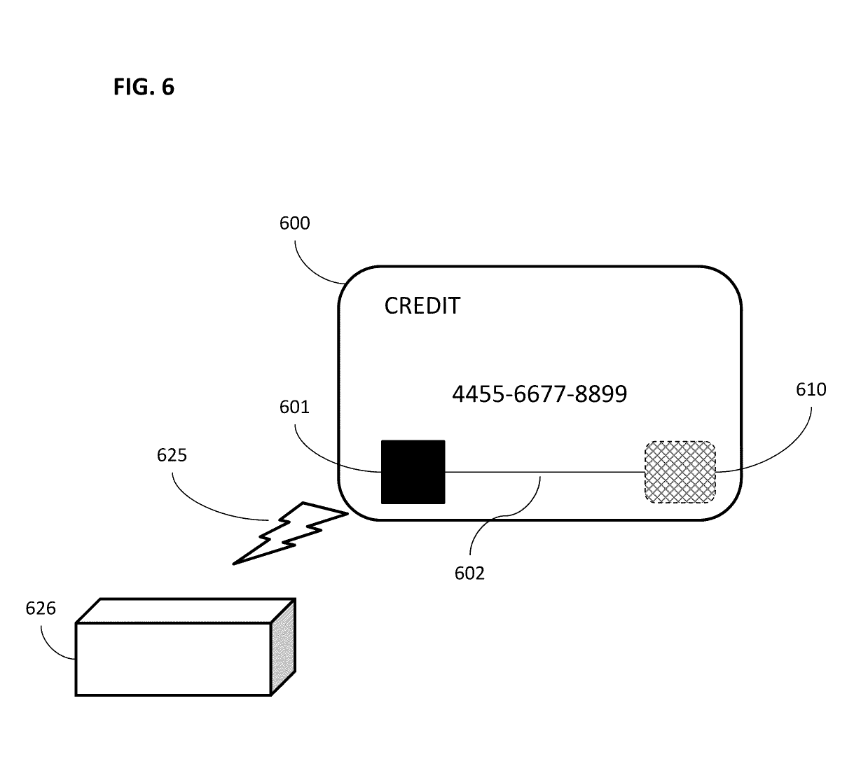

FIG. 6 shows an embodiment of a credit card 600 comprising a contactless chip 601 and a cueing panel 610. The cueing panel 610 may be implemented as an LCD panel. The contactless chip 601 may be connected to the cueing panel 610 via a wire(s) 602. The contactless chip 601 may communicate with a POS device 626 via wireless interface 625 when payments or deposits are made to the account accessed by the credit card 600. The contactless chip 601 may also receive an account balance via wireless interface 625 and POS device 626.

The cueing panel 610 is shown as a crosshatched area warning the customer that the current balance is negative.

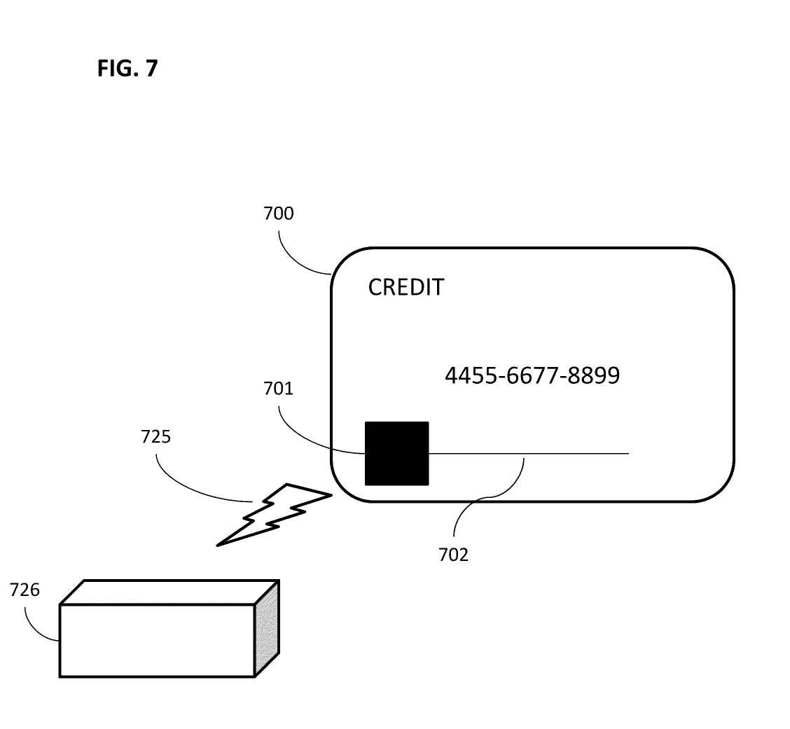

FIG. 7 shows an embodiment of a credit card 700 comprising a contactless chip 701 and a wire(s) 702 where the entirety of the credit card 700 may be configured as a cueing panel. The credit card 700 may be implemented as an LCD panel. The contactless chip 701 may be connected to the credit card 700 via a wire(s) 702. Contactless chip 701 may communicate with a POS device 726 via wireless interface 725 when payments or deposits are made to the account accessed by the credit card 700.

The credit card 700 is shown unchanged—e.g., a white background, indicating a well funded account. The credit card 700 may present a different visual cue to indicate different circumstances concerning the account.

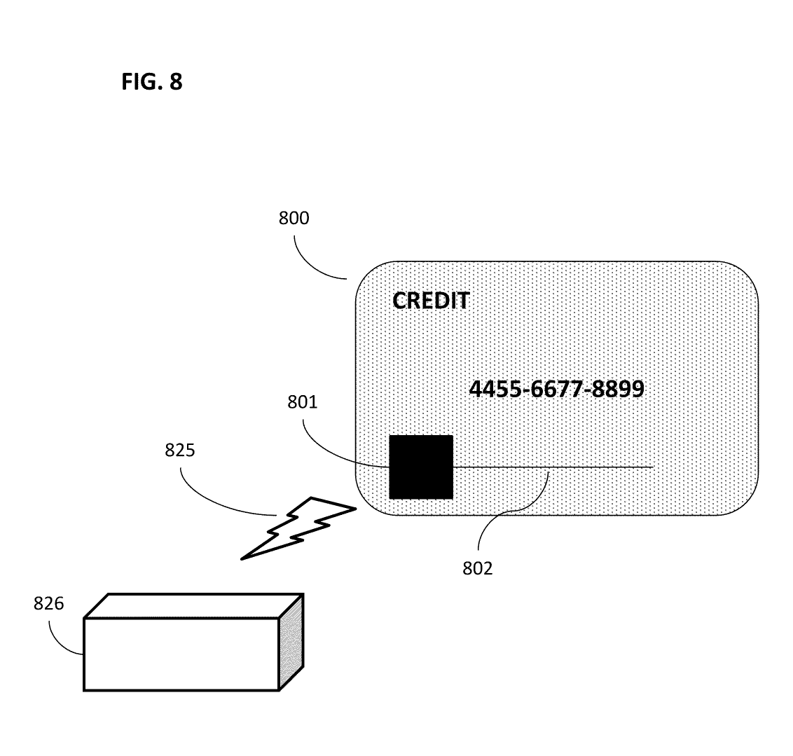

FIG. 8 shows an embodiment of a credit card 800 comprising a contactless chip 801 and a wire(s) 802 where the entirety of the credit card 800 may be configured as a cueing panel. The credit card 800 may be implemented as an LCD panel. The contactless chip 801 may be connected to the credit card 800 via a wire(s) 802. Contactless chip 801 may communicate with a POS device 826 via wireless interface 825 when payments or deposits are made to the account accessed by the credit card 800.

The credit card 800 is shown as a stippled area warning the customer that the current account balance has fallen below a preset threshold.

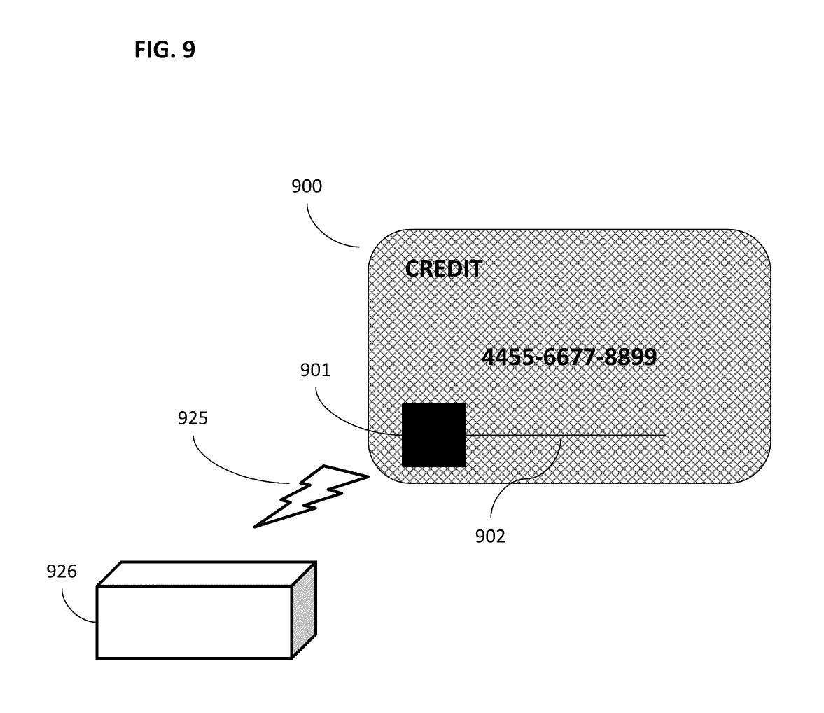

FIG. 9 shows an embodiment of a credit card 900 comprising a contactless chip 901 and a wire(s) 902 where the entirety of the credit card 900 may be configured as a cueing panel. The credit card 900 may be implemented as an LCD panel. The contactless chip 901 may be connected to the credit card 900 via a wire(s) 902. Contactless chip 901 may communicate with a POS device 926 via wireless interface 925 when payments or deposits are made to the account accessed by the credit card 900.

The credit card 900 is shown as a crosshatched area warning the customer that the current balance is negative.

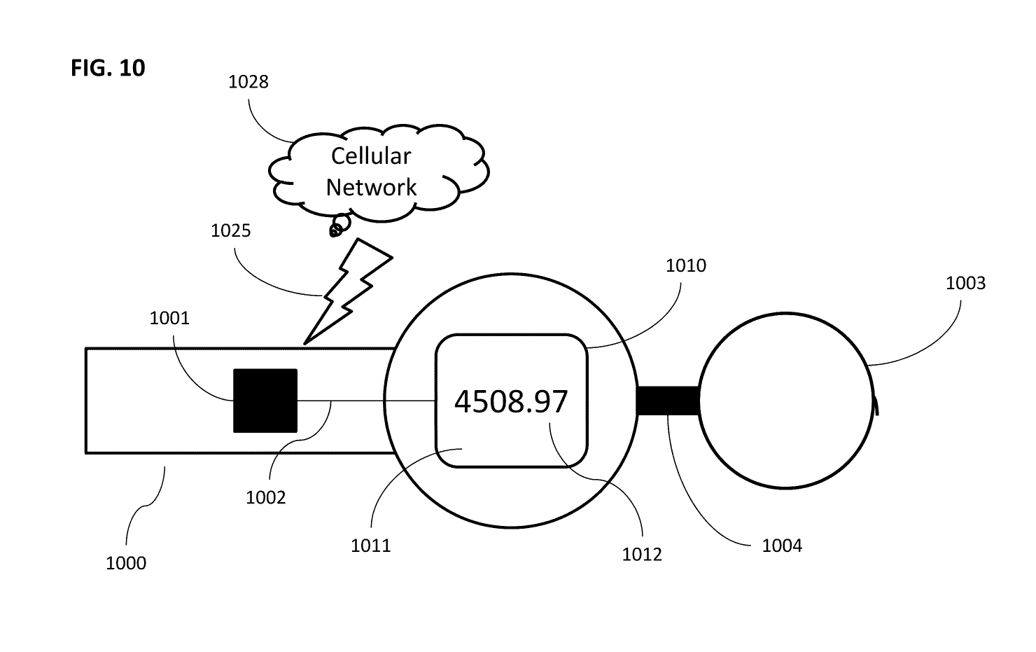

FIG. 10 shows an embodiment of a key fob 1000 according to the invention comprising a wireless chip 1001, a cueing panel 1010, a link 1004 and a key ring 1003. The wireless chip 1001 is connected to the cueing panel 1010 via a wire(s) 1002. The cueing panel 1010 comprises a background 1011 and a numeric display 1012. The cueing panel 1010 may be comprised of an LCD display but other technologies such as LED displays or any other display technology may be used.

The wireless chip 1001 may communicate with a cellular network 1028 a wireless interface 1025 with the bank where the account is held. When the wireless chip 1001 receives account information from the bank where the account is held, wireless chip 1001 may change a visual cue presented by the cueing panel 1010 via the wire(s) 1002 as is appropriate given the current balance of the account. The current balance of the account shown by the visual cue of the cueing panel 1010 may reflect the account balance either before or after the current transaction.

The background 1011 is shown unchanged—e.g., a white background indicating a well funded account. The background 1011 may change its appearance to indicate different circumstances concerning the account. The numeric display 1012 may show the current balance of the account or any other useful information. The colors of the digits (not shown) may also be used as a visual cue to indicate account information—e.g., red colored digits shown by the numeric display 1012 may be an indication of a negative number.

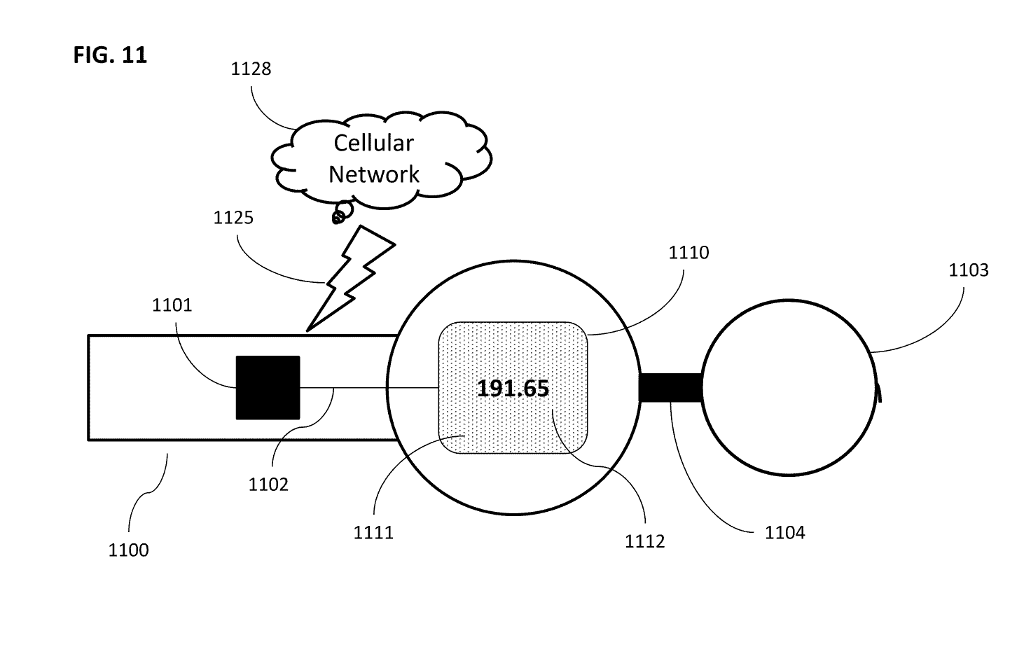

FIG. 11 shows an embodiment of a key fob 1100 according to the invention comprising a wireless chip 1101, a cueing panel 1110, a link 1104 and a key ring 1103. The wireless chip 1101 is connected to the cueing panel 1110 via a wire(s) 1102. The cueing panel 1110 comprises a background 1111 and a numeric display 1112.

The wireless chip 1101 may communicate with a cellular network 1128 a wireless interface 1125 with the bank where the account is held. When the wireless chip 1101 receives account information from the bank where the account is held, wireless chip 1101 may change a visual cue presented by the cueing panel 1110 via the wire(s) 1102 as is appropriate given the current balance of the account.

The background 1111 of the cueing panel 1110 is shown as a stippled area warning the customer that the current account balance has fallen below a preset threshold.

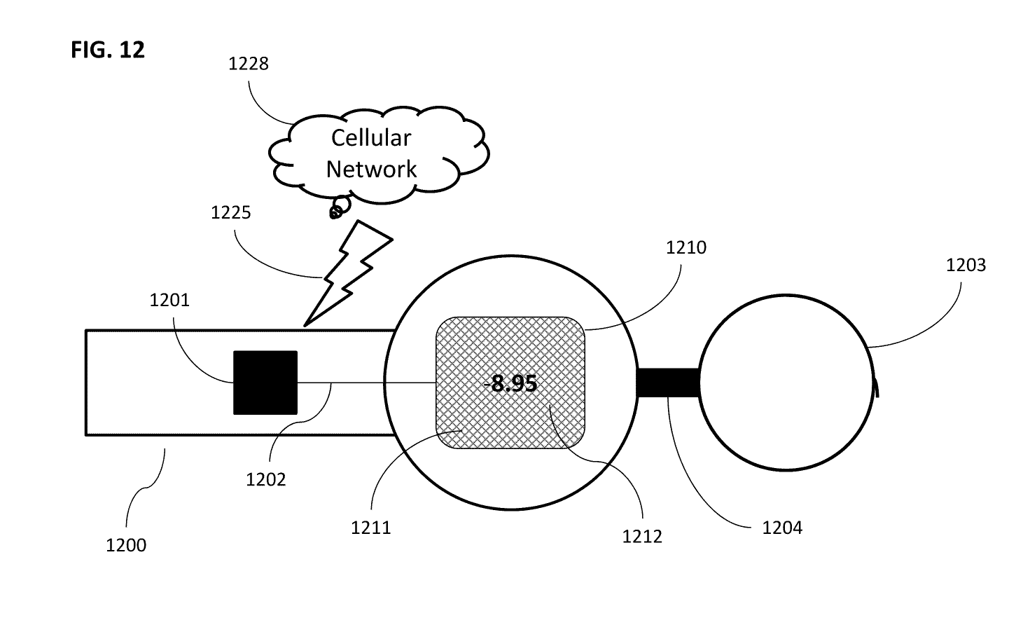

FIG. 12 shows an embodiment of a key fob 1200 according to the invention comprising a wireless chip 1201, a cueing panel 1210, a link 1204 and a key ring 1203. The wireless chip 1201 is connected to the cueing panel 1210 via a wire(s) 1202. The cueing panel 1210 comprises a background 1211 and a numeric display 1212.

The wireless chip 1201 may communicate with a cellular network 1228 a wireless interface 1225 with the bank where the account is held. When the wireless chip 1201 receives account information from the bank where the account is held, wireless chip 1201 may change a visual cue presented by the cueing panel 1210 via the wire(s) 1202 as is appropriate given the current balance of the account.

The background 1211 of the cueing panel 1210 is shown as a crosshatched area warning the customer that the current balance is negative.

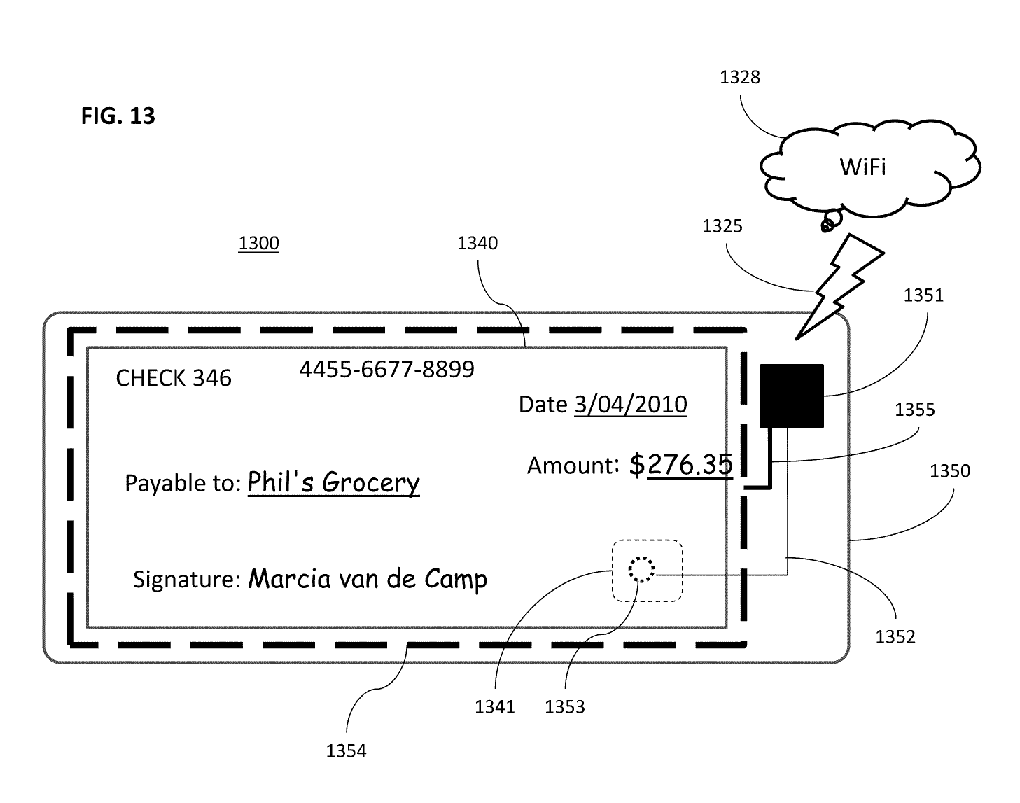

FIG. 13 shows an embodiment of a check book system 1300 according to the invention comprising a check 1340 and a check holder 1350. The check 1340 is preferable comprised of a thin flexible material—e.g., paper. The check 1340 further comprises a cueing panel 1341. The cueing panel 1341 may be comprised of a designated area of the check 1340 which has been treated with a color changing ink. In one embodiment of the invention the color changing ink is photochromic. Other embodiments of the invention may use electrochromic or thermochromic ink as the color changing ink.

The check holder 1350 is comprised of a WiFi chip 1351, a LED 1353, and an Optical Character Recognition (OCR) panel 1354 hereinafter referred to as a OCR panel 1354. The WiFi chip 1351 is connected to a LED 1352 via a wire(s) 1352. The WiFi chip 1351 is connected to the OCR panel 1354 via a wire(s) 1355.

The WiFi chip 1351 may communicate with the bank where the account is held via a WiFi network 1328 using a WiFi interface 1325. When the WiFi chip 1351 receives account information from the bank where the account is held, it may change a visual cue presented by the cueing panel 1341 by illuminating the LED 1353 via the wire(s) 1352. The photochromic ink of the cueing panel 1341 is sensitive; it changes in response to the light produced by LED 1353.

The embodiment in shown by FIG. 13 shows a single LED for illumination of the cueing panel 1341. In this embodiment a large amount of illumination from LED 1353 will produce one pattern, a moderate amount of illumination from LED 1353 will produce a second pattern and the absence of a pattern is produced when the LED 1353 does not illuminate the cueing panel 1341. Other embodiments using multiple types of photochromic ink, each being sensitive to different wavelengths of light along with multiple LEDs 1353 disposed within check holder 1350, may also be used to display distinct patterns and/or colors in the cueing panel 1341.

The cueing panel 1341 is shown unchanged—e.g., a white background, indicating a well funded account. The cueing panel 1341 may present a different visual cue to indicate different circumstances concerning the account.

The OCR panel 1354 may be used to recognize the value of the check 1340 after it is written and may send that value to the WiFi chip 1351 via a wire(s) 1355. The value of the check 1340 may be combined with the bank balance received by the WiFi chip 1351 via WiFi connection 1325 to produce a current bank balance. The value of the current bank balance may be used as the impetus to change the visual cue presented by the cueing panel 1341. The value of the check 1340 may also be sent by the WiFi chip 1351 via the WiFi connection 1325 and the WiFi network 1328 to the bank to update the account balance.

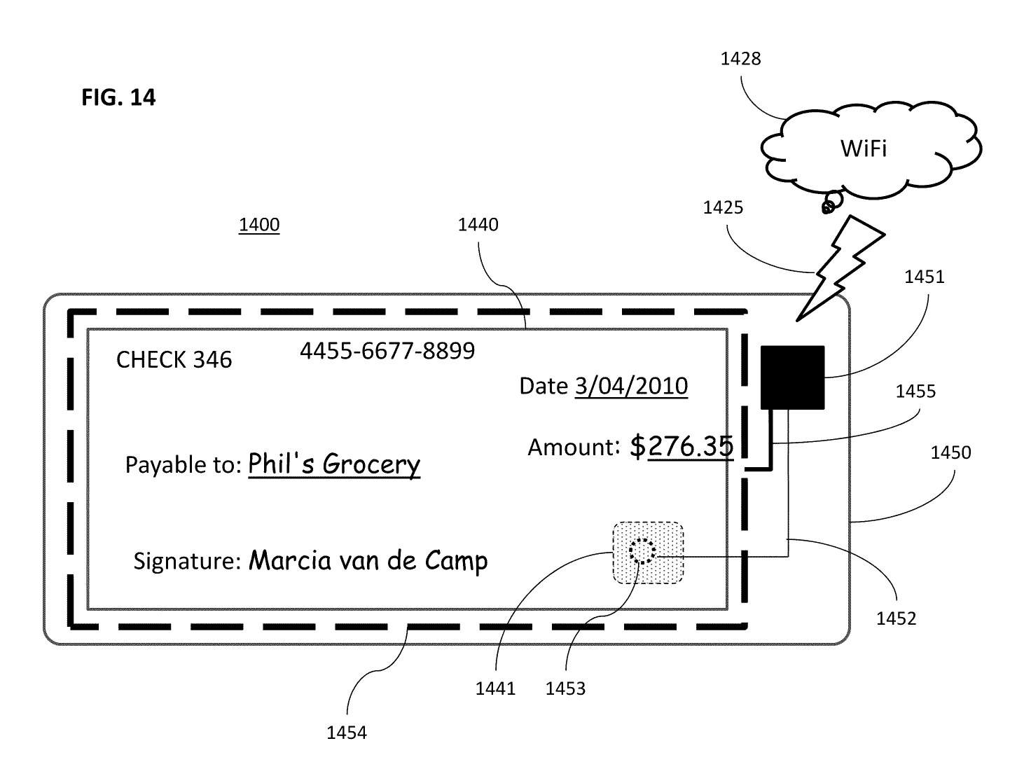

FIG. 14 shows an embodiment of a check book system 1400 according to the invention comprising a check 1440 and a check holder 1450. The check 1440 further comprises a cueing panel 1441.

The check holder 1450 is comprised of a WiFi chip 1451, a LED 1453, and an OCR panel 1454. The WiFi chip 1451 is connected to a LED 1452 via a wire(s) 1452. The WiFi chip 1451 is connected to the OCR panel 1454 via a wire(s) 1455.

The WiFi chip 1451 may communicate with the bank where the account is held via a WiFi network 1428 using a WiFi interface 1425. When the WiFi chip 1451 receives account information from the bank where the account is held, it may change a visual cue presented by the cueing panel 1441 by illuminating the LED 1453 via the wire(s) 1452.

The cueing panel 1441 is shown as a stippled area warning the customer that the current account balance has fallen below a preset threshold.

The OCR panel 1454 may be used to recognize the value of the check 1440 after it is written and may send that value to the WiFi chip 1451 via a wire(s) 1455. The value of the check 1440 may be combined with the bank balance received by the WiFi chip 1451 via WiFi connection 1425 to produce a current bank balance. The value of the current bank balance may be used as the impetus to change the visual cue presented by the cueing panel 1441.

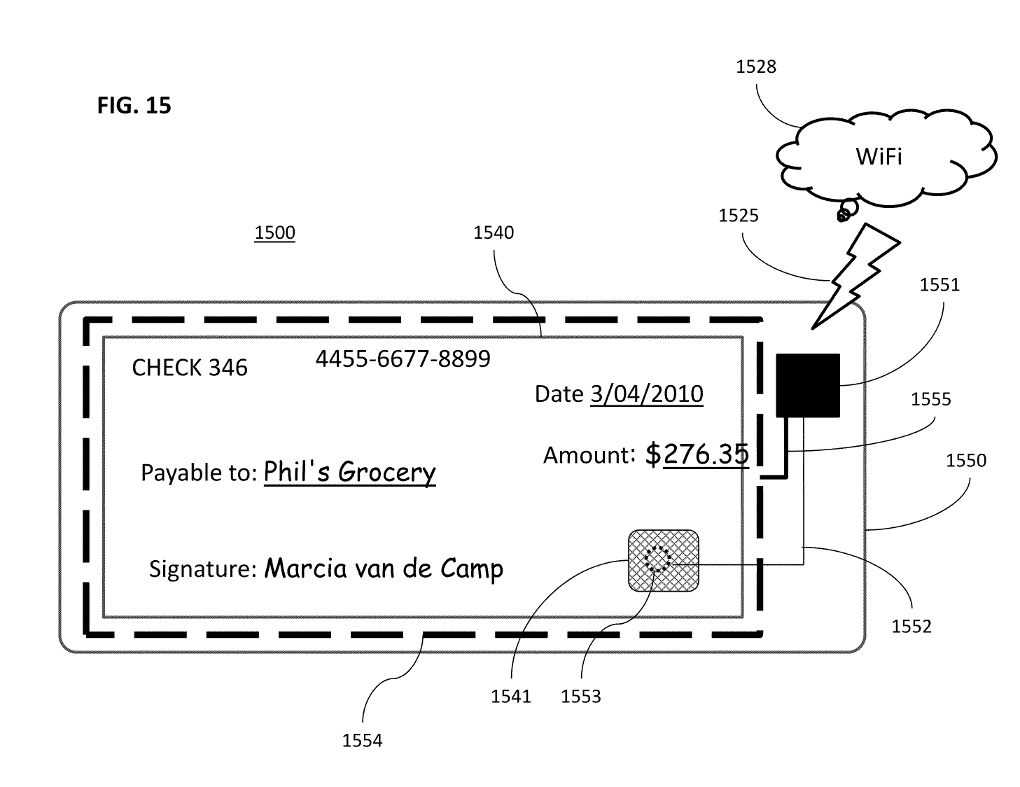

FIG. 15 shows an embodiment of a check book system 1500 according to the invention comprising a check 1540 and a check holder 1550. The check 1540 further comprises a cueing panel 1541.

The check holder 1550 is comprised of a WiFi chip 1551, a LED 1553, and an OCR panel 1554. The WiFi chip 1551 is connected to a LED 1552 via a wire(s) 1552. The WiFi chip 1551 is connected to the OCR panel 1554 via a wire(s) 1555.

The WiFi chip 1551 may communicate with the bank where the account is held via a WiFi network 1528 using a WiFi interface 1525. When the WiFi chip 1551 receives account information from the bank where the account is held, it may change a visual cue presented by the cueing panel 1541 by illuminating the LED 1553 via the wire(s) 1552.

The cueing panel 1541 is shown as a crosshatched area warning the customer that the current balance is negative.

The OCR panel 1554 may be used to recognize the value of the check 1540 after it is written and may send that value to the WiFi chip 1551 via a wire(s) 1555. The value of the check 1540 may be combined with the bank balance received by the WiFi chip 1551 via WiFi connection 1525 to produce a current bank balance. The value of the current bank balance may be used as the impetus to change the visual cue presented by the cueing panel 1541.

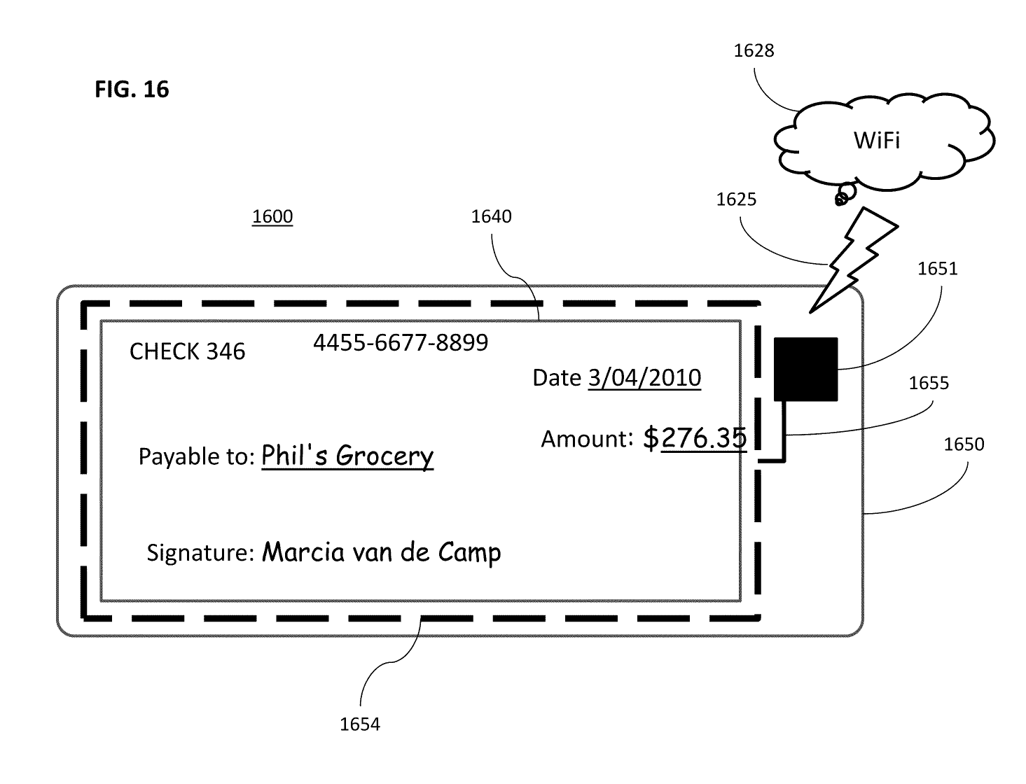

FIG. 16 shows an embodiment of a check book system 1600 according to the invention comprising a check 1640 and a check holder 1650. The check 1640 may be comprised of any thin flexible material—e.g., paper. The entirety of the check 1640 comprises a cueing panel. The check 1640 may be treated with a color changing ink. In one embodiment the color changing ink is photochromic. Other embodiments may use electrochromic or thermochromic ink as the color changing ink.

The check holder 1650 is comprised of a WiFi chip 1651, and an OCR panel 1654. The WiFi chip 1651 is connected to the OCR panel 1654 via a wire(s) 1655.

The WiFi chip 1651 may communicate with the bank where the account is held via a WiFi network 1628 using a WiFi interface 1625. When the WiFi chip 1651 receives account information from the bank where the account is held, it may change a visual cue presented by presented by the check 1640 by illuminating the OCR panel 1654. The photochromic ink of the check 1640 is sensitive to the light produced by the OCR panel 1654.

The embodiment of FIG. 16 shows the OCR panel 1654 illuminating the entirety of the check 1640. In this embodiment a large amount of illumination from the OCR panel 1654 will produce one pattern, a moderate amount of illumination from the OCR panel 1654 will produce a second pattern and the absence of a pattern, is produced when the OCR panel 1654 does not illuminate the check 1640.

The OCR panel 1654 may be comprised of a waveguide illuminated by one or more LEDs. In the alternative the entirety of the OCR panel 1654 panel may comprised of an LCD shutter which allows light from a collection of LEDs to illuminate the check 1640. Other illumination methods such as OLEDs are also included within the scope of the invention. In yet another embodiment multiple types of photochromic ink, each being sensitive to different wavelengths of light along with multiple illumination sources for the OCR panel 1654 may be used to produce distinct patterns and/or colors in the check 1640.

The check 1640 is shown unchanged—e.g., a white background, indicating a well funded account. The check 1640 may change its appearance to indicate different circumstances concerning the account.

The OCR panel 1654 may be used to recognize the value of the check 1640 after it is written and may send that value to the WiFi chip 1651 via a wire(s) 1655. The value of the check 1640 may be combined with the bank balance received by the WiFi chip 1651 via WiFi connection 1625 to produce a current bank balance. The value of the current bank balance may be used as the impetus to change the visual cue presented by the cueing panel 1641. The value of the check 1640 may also be sent by the WiFi chip 1651 via the WiFi connection 1625 and the WiFi network 1628 to the bank to update the account balance.

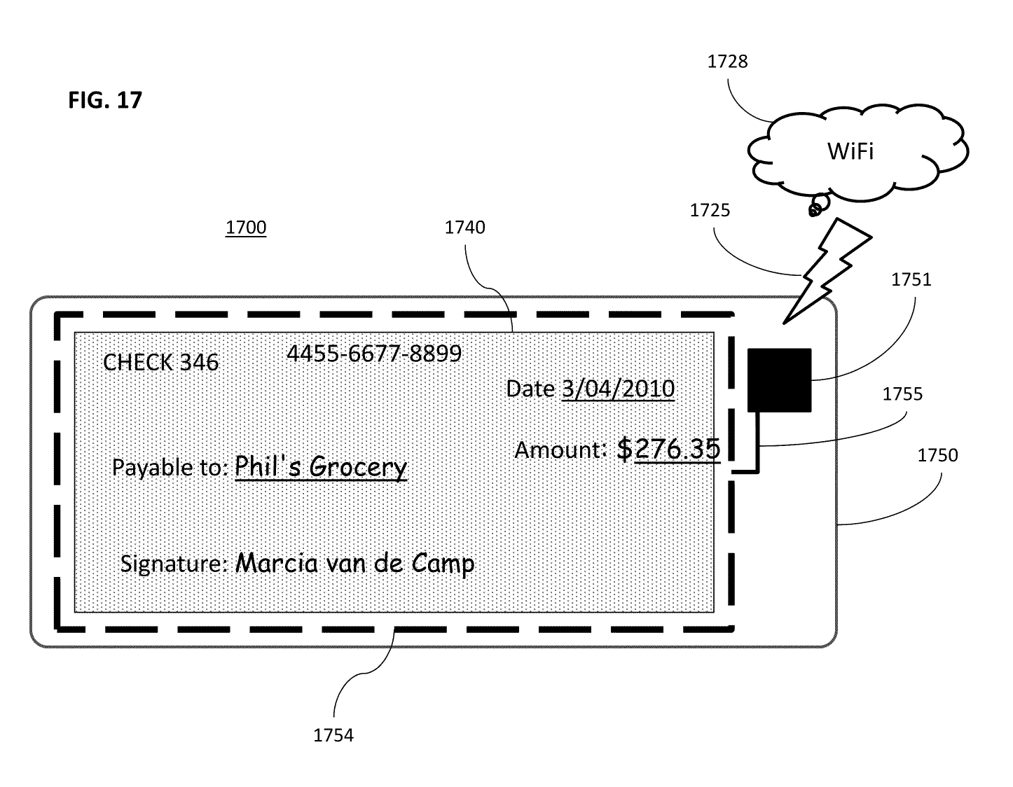

FIG. 17 shows an embodiment of a check book system 1700 according to the invention comprising a check 1740 and a check holder 1750. The check 1740 may be comprised of any thin flexible material—e.g., paper. The entirety of the check 1740 comprises a cueing panel. In one embodiment the color changing ink is photochromic.

The check holder 1750 is comprised of a WiFi chip 1751, and an OCR panel 1754. The WiFi chip 1751 is connected to the OCR panel 1754 via a wire(s) 1755.

The WiFi chip 1751 may communicate with the bank where the account is held via a WiFi network 1728 using a WiFi interface 1725. When the WiFi chip 1751 receives account information from the bank where the account is held, it may change a visual cue presented by presented by the check 1740 by illuminating the OCR panel 1754.

The check 1740 is shown as a stippled area warning the customer that the current account balance has fallen below a preset threshold.

The OCR panel 1754 may be used to recognize the value of the check 1740 after it is written and may send that value to the WiFi chip 1751 via a wire(s) 1755. The value of the check 1740 may be combined with the bank balance received by the WiFi chip 1751 via WiFi connection 1725 to produce a current bank balance. The value of the current bank balance may be used as the impetus to change the visual cue presented by the cueing panel 1741. The value of the check 1740 may also be sent by the WiFi chip 1751 via the WiFi connection 1725 and the WiFi network 1728 to the bank to update the account balance.

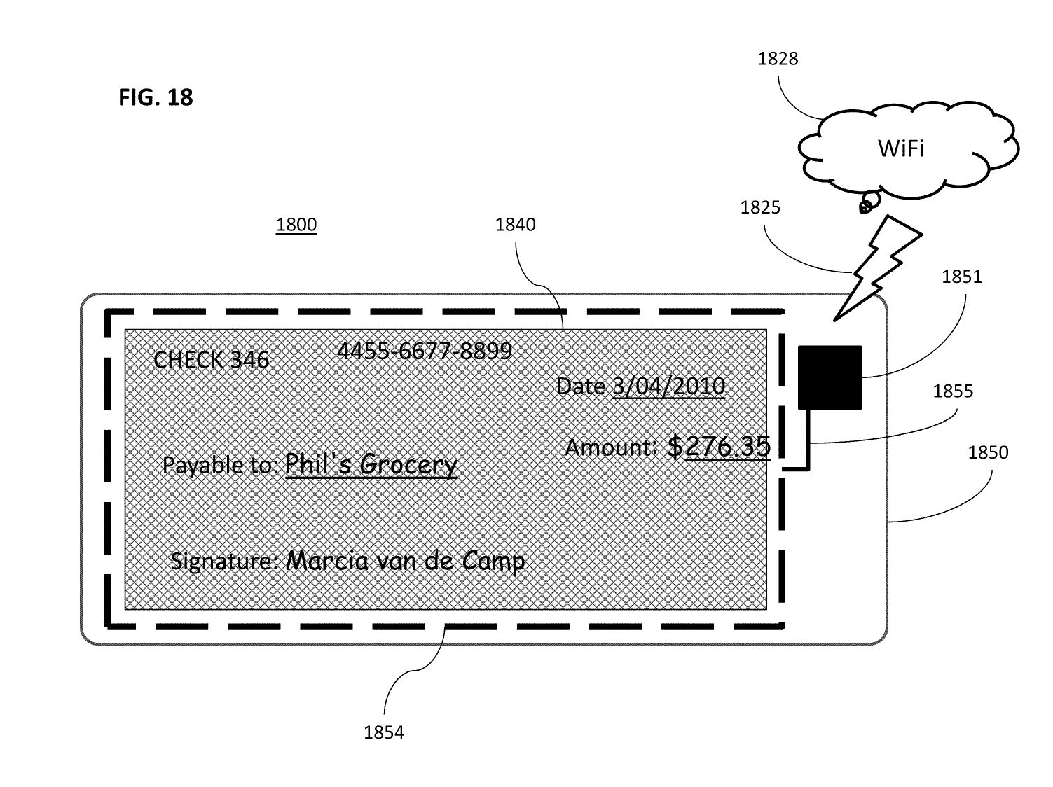

FIG. 18 shows an embodiment of a check book system 1800 according to the invention comprising a check 1840 and a check holder 1850. The check 1840 may be comprised of any thin flexible material—e.g., paper. The entirety of the check 1840 comprises a cueing panel. In one embodiment the color changing ink is photochromic.

The check holder 1850 is comprised of a WiFi chip 1851, and an OCR panel 1854. The WiFi chip 1851 is connected to the OCR panel 1854 via a wire(s) 1855.

The WiFi chip 1851 may communicate with the bank where the account is held via a WiFi network 1828 using a WiFi interface 1825. When the WiFi chip 1851 receives account information from the bank where the account is held, it may change a visual cue presented by presented by the check 1840 by illuminating the OCR panel 1854.

The check 1840 is shown as a crosshatched area warning the customer that the current balance is negative.

The OCR panel 1854 may be used to recognize the value of the check 1840 after it is written and may send that value to the WiFi chip 1851 via a wire(s) 1855. The value of the check 1840 may be combined with the bank balance received by the WiFi chip 1851 via WiFi connection 1825 to produce a current bank balance. The value of the current bank balance may be used as the impetus to change the visual cue presented by the cueing panel 1841. The value of the check 1840 may also be sent by the WiFi chip 1851 via the WiFi connection 1825 and the WiFi network 1828 to the bank to update the account balance.

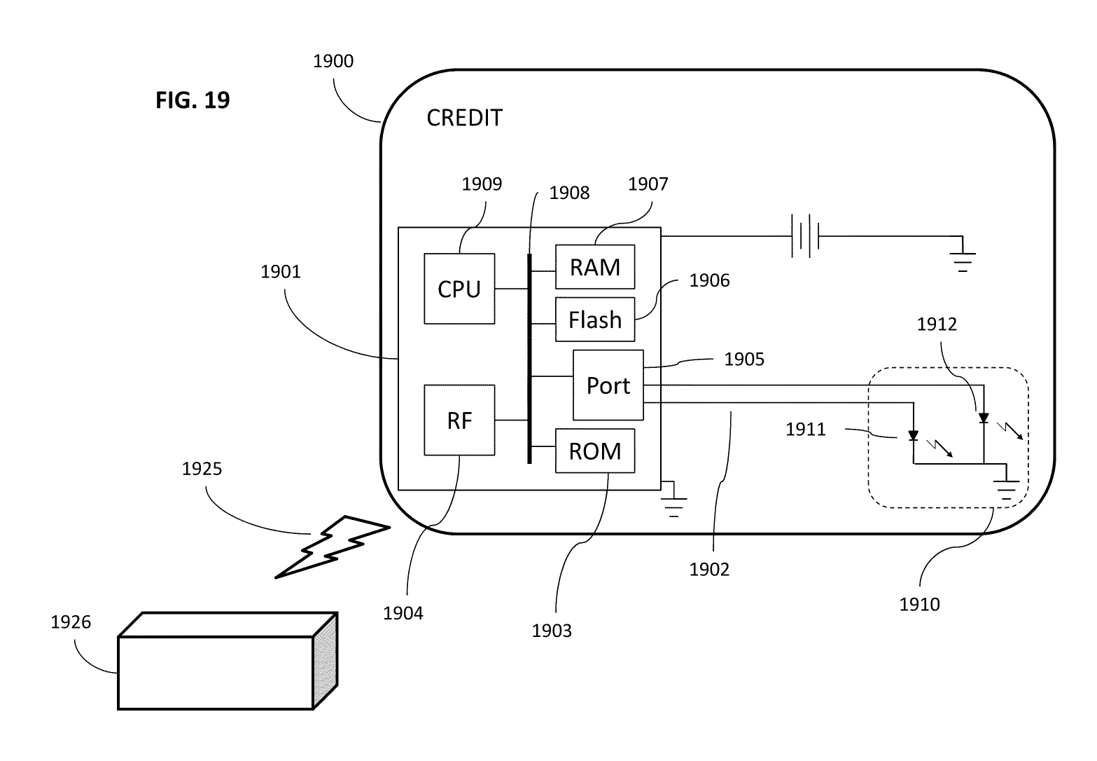

FIG. 19 shows an embodiment of a credit card 1900 comprising a contactless chip 1901 and a cueing panel 1910. The cueing panel 1910 may be implemented as a translucent panel which may be illuminated by a LED 1911, an LED 1912 or by a combination of LED 1911 and LED 1912. Preferably, LED 1911 would produce light of a different color than the light produced by the LED 1912. Preferably, LED 1911 would produce light of a different color than the light produced LED 1912. Preferably, the combination of light from LED 1911 and LED 1912 produces a third color—e.g., a red LED and green LED would produce red, yellow and green light.

Contactless chip 1901 may be connected to cueing panel 1910 via a wire(s) 1902. The embodiment shown in FIG. 19 includes two (2) wires 1902. Contactless chip 1901 also includes a Computer Processing Unit (CPU) 1909 which executes instructions stored in a Flash memory 1906 or a Read Only Memory (ROM) 1903. Data and instructions may be stored in a Random Access Memory (RAM) 1907 as is known in the art. A port 1905 may be used to control the light output of LED 1911 and LED 1912.

Contactless chip 1901 may communicate with a Point of Sale (POS) device 1926 via wireless module 1904 and interface 1925 when payments or deposits are made to the account accessed by credit card 1900. Contactless chip 1901 may also receive an account balance via wireless interface 1925 and POS device 1926.

Although systems 100-300 uses an Internet network, credit cards 400-900 uses a contactless connection, fobs 1000-1200 use a cellular network and check systems 1300-1800 use a WiFi network each system may use the network or connection of the other within the scope of the invention—e.g., the fobs 1000-1200 may use a contactless connection and the check system 1300-1800 may use a cellular network for connectivity.

Although some of the embodiments shown use a portion or the entirety of a credit card as the carrier for the cueing panel other cards such as debit cards or banking cards are also included within the scope of the invention. Medical charge account cards or public transportation cards, casino value cards or any other card or mechanism that may be used to access an account containing items of value or themselves act as holders of value are included within the scope of this invention.

Although the implementation of the cueing panel on the credit card embodiments is described as an LCD panel other embodiments are possible Alternate embodiments may include the use of an LED or group of LEDs. Still other embodiments may include using an LED to illuminate a portion or the entirety of the credit card with or without the use of a light guide. All of these embodiments are included within the scope of the invention.

Various technologies for implementation of the cueing mechanism have been described thus far. The credit cards 400-900 and fobs 1000-1200 use an LCD display. The check systems 1300-1800 use color changing ink. Each system may utilize the cueing panel mechanism of the other within the scope of the invention. For example the credit card 400 may use the LED and the color changing ink described by the check system 1300. It should be noted that the cueing panel in any of the foregoing embodiments may also be configured to show alpha-numeric symbols and/or other characters.

The check systems 1300-1800 describe the use of photochromic ink activated by an appropriate LED. However other embodiments may be used instead of or in conjunction with the previously described photochromic system. For example, checks could be made with multiple contact points which would engage contacts on the check holder to activate electrochromic ink. In another embodiment checks could be treated with thermochromic ink and the check holder could activate a heating element to activate that ink.

Although the embodiment shown thus far describe a cueing panel displaying black and white patterns, other patterns may be used either in conjunction with the black and white patterns or by themselves. For example, such patterns may include a face with a smile as an indication of a well funded account and a face with a frown indicating that a current account balance has fallen below a preset threshold. These patterns and symbols as well as equivalent symbols are included within the scope of the invention. Iconic symbols or emoticons indicating various emotions are also included within the scope of the invention.

Although the embodiments described show the use of a cueing panel using black and white indications other embodiments may make use of colors as part of a cue. In particular the unchanged state may be any color or pattern including bank logos and the like.

Combinations of audio cues, tactile cues, black and white patterns, emoticons and color cues may be used together or separately.

The cueing panel may also include other information such as the current balance of the account, offers of overdrafts etc.

We have presented three different states for the cues regarding an account. Other states and more than three states are included within the scope of the invention.

We have presented a preset threshold for one of the states but other thresholds are possible such a programmable thresholds set by a bank, by a customer or by a regulatory agency. The threshold can vary according to market conditions or the creditworthiness of the customer.

Thus, systems and methods for providing visual feedback for a banking customer have been provided. Persons skilled in the art will appreciate that the present invention can be practiced by other than the described embodiments, which are presented for purposes of illustration rather than of limitation, and that the present invention is limited only by the claims that follow.

What is claimed is:

1. A credit card for providing cues to a banking customer, the credit card comprising:
a cueing panel;
an integrated silicon chip wherein the chip further comprises:
a computer processing unit;
a memory;
a communications module; and
an output signal transmission media connected between the communications module and the cueing panel;
wherein the communications module is configured to receive an electronic signal relating to the banking customer's account balance, store information corresponding to the signal in the memory, and transmit an output signal corresponding to the signal in response to an instruction from the computer processing unit to the cueing panel via the output signal transmission media.

2. The credit card of claim 1 further configured to be used with a point of sale device.

3. The credit card of claim 2 wherein the credit card receives a transaction value from the point of sale device.

4. The credit card of claim 3 wherein the credit card activates a predetermined state of the cueing panel in response to a determination of the banking customer's current account balance minus the value received from a point of sale device.

5. The credit card of claim 3 wherein the credit card activates a predetermined state of the cueing panel in response to the comparison of a threshold value with the evaluation of the current account balance minus the value.

6. A key fob for providing cues to a banking customer, the key fob comprising:
a cueing panel;
and an integrated silicon chip wherein the chip further comprises:
a communications module for receiving electronic signals relating to the banking customer's account balance;
a computer processing unit for storing the electronic signal in a computer memory; and
wherein the computer processing unit is further configured to command the communications module to transmit an output signal to the cueing panel, said output signal being based, at least in part, on the electronic signal.

7. The key fob of claim 6 wherein the key fob is configured to be used with a point of sale device.

8. The key fob of claim 7 wherein the key fob receives a transaction value from the point of sale device.

9. The key fob of claim 8 wherein the key fob activates a state of the cueing panel in response to the evaluation of the current account balance minus the value.

10. The key fob of claim 8 wherein the key fob activates a state of the cueing panel in response to the comparison of a threshold value with the evaluation of the current account balance minus the value.

11. A financial instrument preparation device for providing cues to a banking customer, the financial instrument preparation device comprising:
a cueing panel;
and an integrated silicon chip wherein the chip further comprises:
a communications module for receiving an electronic signal relating to the banking customer's account balance;
a computer processing unit for storing the electronic signal in a computer memory; wherein the computer processing unit is further configured to instruct the communications module to transmit an output signal to the cueing panel, said output signal being based, at least in part, on the electronic signal.

12. The financial instrument preparation device of claim 11 wherein the financial instrument preparation device is configured to receive a transaction value from a point of sale device.

13. The financial instrument preparation device of claim 12 wherein the financial instrument preparation device activates a state of the cueing panel in response to the evaluation of a current account balance minus the value.

14. The financial instrument preparation device of claim 13 wherein the financial instrument preparation device activates a state of the cueing panel in response to the comparison of a threshold value with the evaluation of the current account balance minus the value.
